(19) United States
(12) Patent Application Publication
(10) Pub. No.: US 2013/0295274 A1
(43) Pub. Date: Nov. 7, 2013

(54) METHOD FOR MANUFACTURING COLOR FILTER SUBSTRATE

(71) Applicants: Lien-Hsin Lee, Taipei City (TW); Jun-Yong Zhang, Shenzhen (CN); Chia-Ming Hsieh, Keelung City (TW); Ren-Hung Wang, Taichung City (TW)

(72) Inventors: Lien-Hsin Lee, Taipei City (TW); Jun-Yong Zhang, Shenzhen (CN); Chia-Ming Hsieh, Keelung City (TW); Ren-Hung Wang, Taichung City (TW)

(73) Assignee: SHUN ON ELECTRONIC CO., LTD., Hsinchu County (TW)

(21) Appl. No.: 13/517,605

(22) Filed: Jun. 14, 2012

(30) Foreign Application Priority Data
May 7, 2012 (CN) 201210138388.2

(51) Int. Cl. B05D 5/12

(52) U.S. Cl. 427/58

(57) ABSTRACT

A method for manufacturing a color film substrate including the following steps is provided. A substrate is provided. A first conductive black matrix extending along a first direction is formed on the substrate. A color film layer is formed on the substrate, and the normal projections of the color film layer and of the first conductive black matrix on the substrate are not overlapping. A plurality of insulating spacers is formed on the first conductive black matrix, and the height of the insulating spacers is greater than the thickness of the color film layer. A second conductive black matrix extending along a second direction and covering the insulating spacers is formed on the substrate. A passivation layer is formed for covering the first conductive black matrix, the color film layer, the insulating spacers and the second conductive black matrix. A transparent conductive layer is formed on the passivation layer.

### CROSS-REFERENCE TO RELATED APPLICATION

This application claims the priority benefit of China application serial no. 201210138388.2, filed on May 7, 2012. The entirety of the above-mentioned patent application is hereby incorporated by reference herein and made a part of this specification.

### BACKGROUND OF THE INVENTION

1. Field of the Invention

The invention relates to a method for manufacturing a color film substrate, and more particularly, to a manufacturing method for a color film substrate having a touch function.

2. Description of Related Art

In recent year, following the rapid development and application of the information technology, wireless mobile communication and information appliance, input devices of many information products have transformed from keyboards and mice to touch panels in order to achieve more convenience, lighter volume and more humaneness, wherein the touch display device is currently the most popular product.

Conventional touch panel generally may be classified as conductive, resistive and photosensitive, in which the conductive touch panel is particularly the mainstream product. If classification basing on the structural constitutions, the touch panel may be classified into two major types, the on-cell type and the in-cell type, wherein the in-cell type touch panel may be integrated with the entire panel manufacturing process (such as the manufacturing process of color film substrate), and is contributive in reducing the thickness of the product in compliance with the trend of miniaturization.

The manufacture of the conventional touch color film substrate is to sequentially form the bottom electrode layer, the insulating layer, the top electrode layer, the color film layer, the passivation layer, the common electrode layer, and the spacers on the substrate. The bottom electrode layer is disposed on the substrate, and the insulating layer is located between the top electrode layer and the bottom electrode layer, wherein the top electrode layer and the bottom electrode layer are both being the black matrix. The color film layer comprises a plurality of color filter units respectively disposed on the substrate while not overlapping with the bottom electrode layer. The passivation layer covers the color film layer, the top electrode layer and the bottom electrode layer, the common electrode layer is disposed on the passivation layer, and the spacers ares disposed on the common electrode layer.

Accordingly, the manufacture of the conventional touch color film substrate in comparison with the general manufacture of the color film substrate has two additional process steps, which are the step of manufacturing the insulating layer for electrical insulating the top electrode layer and the bottom electrode layer, and the step of manufacturing the top electrode layer, and thus the manufacturing process is much more complicated and not able to ensure the process yield. Therefore, improving the manufacture of the touch color film substrate to further reduce the process steps and enhance the process yield is practically a major issue for the production technology of the touch color film substrate to overcome.

### SUMMARY

The invention provides a method for manufacturing a color film substrate, which has an insulating spacer capable of being an insulating layer, that may effectively reduce the process steps and lower the production cost.

The invention provides a method for manufacturing a color film substrate comprising the following steps. A substrate is provided. A first conductive black matrix extending along a first direction is formed on the substrate. A color film layer on the substrate is formed, and the normal projections of the color film layer and of the first conductive black matrix on the substrate are not overlapping. A plurality of insulating spacers is formed on the first conductive black matrix, and the height of the plurality of insulating spacers is greater than the thickness of the color film layer. A second conductive black matrix is formed on the substrate, wherein the second conductive black matrix extends along a second direction and covers the insulating spacers, and the second direction intersects with the first direction. A passivation layer is formed for covering the first conductive black matrix, the color film layer, the plurality of insulating spacers, and the second conductive black matrix. A transparent conductive layer is formed on the passivation layer.

The invention further provides a method for manufacturing a color film substrate comprising the following steps. A substrate is provided. A first conductive black matrix extending along a first direction is formed on the substrate. A color film layer is formed on the substrate, and the normal projections of the color film layer and of the first conductive black matrix on the substrate are not overlapping. A plurality of first spacers is formed on the first conductive black matrix, and the height of the plurality of first spacers and the thickness of the first conductive black matrix in total are equal to the thickness of the color film layer. The materials of the plurality of first spacers and of the color film layer are the same. A second conductive black matrix is formed on the substrate, wherein the second conductive black matrix extends along a second direction and covers the plurality of first spacers, and the second direction intersects with the first direction. A passivation layer is formed for covering the first conductive black matrix, the color film layer, the plurality of first spacers, and the second conductive black matrix. A transparent conductive layer is formed on the passivation layer. A plurality of second spacers is formed on the transparent conductive layer, and the normal projections of the second spacer and of the first spacer on the substrate are overlapping.

In an exemplary embodiment, the first conductive black matrix has a plurality of first strip conductive patterns, and the plurality of first strip conductive patterns is electrically insulated from each others.

In an exemplary embodiment, the second conductive black matrix has a plurality of second strip conductive patterns. The plurality of second strip conductive patterns is electrically insulated from each others, and the plurality of second strip conductive patterns is perpendicularly intersected with the plurality of first strip conductive patterns.

In an exemplary embodiment, the materials of the first conductive black matrix and of the second conductive black matrix are comprised of metal or semiconductor material.

In an exemplary embodiment, the color film layer comprises a plurality of red filter films, a plurality of green filter films and a plurality of blue filter films.

In an exemplary embodiment, the color film layer is connected with the plurality of first spacers.

In an exemplary embodiment, the color film layer is not connected with the plurality of first spacers.

Based on the above, as described in the embodiments of the invention, the method for manufacturing the color film substrate is to sequentially form the first conductive black matrix, the color film layer, the insulating spacers, the second conductive black matrix, the passivation layer, and the transparent conductive layer on the substrate, wherein the height of the plurality of insulating spacers is greater than the thickness of the color film layer. Therefore, the plurality of insulating spacers in addition to being the support for sustaining the spacing between the two substrates (e.g., the color film substrate and the opposite substrate) may also be the insulating layer between the first conductive black matrix and the second conductive black matrix. Consequently, in comparison with the conventional method for manufacturing the touch color film substrate, the method for manufacturing the color film substrate of the invention may effectively reduce the manufacturing steps and the production cost.

The abovementioned features and advantages of the invention will become more obvious and better understood with regard to the following description of the exemplary embodiments and accompanying drawings in the below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A to FIG. 1G are schematic top views illustrating a method for manufacturing a color film substrate according to a first exemplary embodiment.

FIG. 2A to FIG. 2G(b) are schematic cross-sectional views illustrating the manufacturing method of the color film substrate depicted in FIG. 1 along a line I-I′.

FIG. 3A to FIG. 3H are schematic top views illustrating a method for manufacturing a color film substrate according to a second exemplary embodiment.

FIG. 4A to FIG. 4H are schematic cross-sectional views illustrating the manufacturing method of the color film substrate depicted in FIG. 3 along a line II-II′.

FIG. 5A is the schematic diagram illustrating the color film substrate depicted in FIG. 2G(b) being applied to the touch display panel.

FIG. 5B is schematic diagram illustrating the color film substrate depicted in FIG. 4H being applied to the touch display panel.

### DESCRIPTION OF EMBODIMENTS

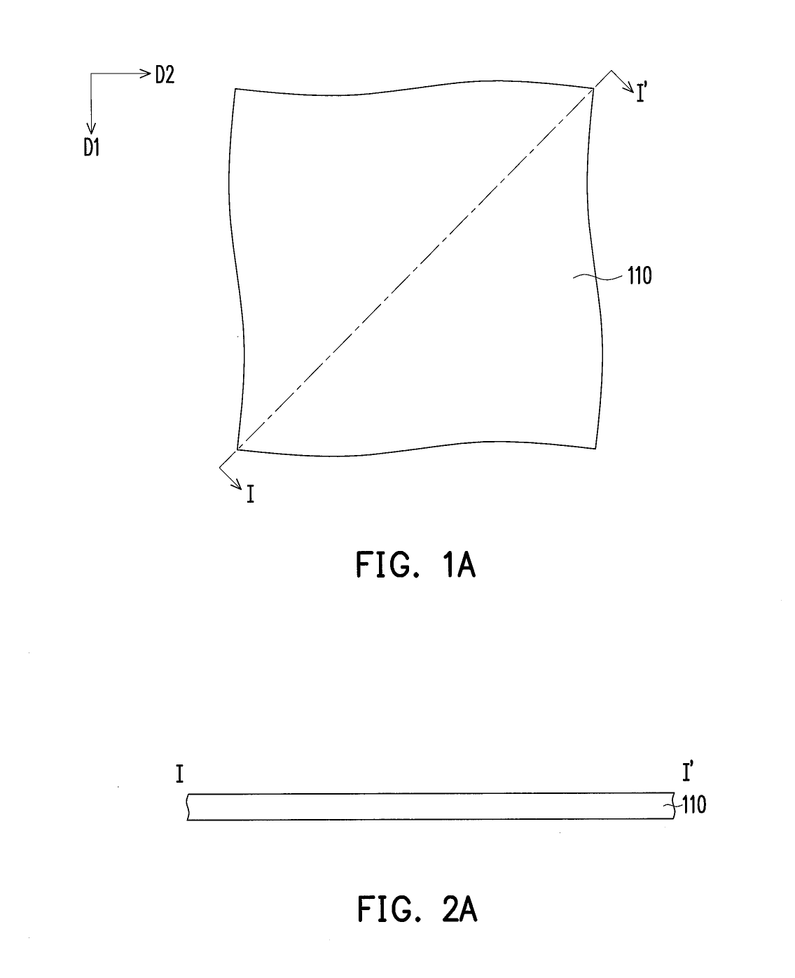

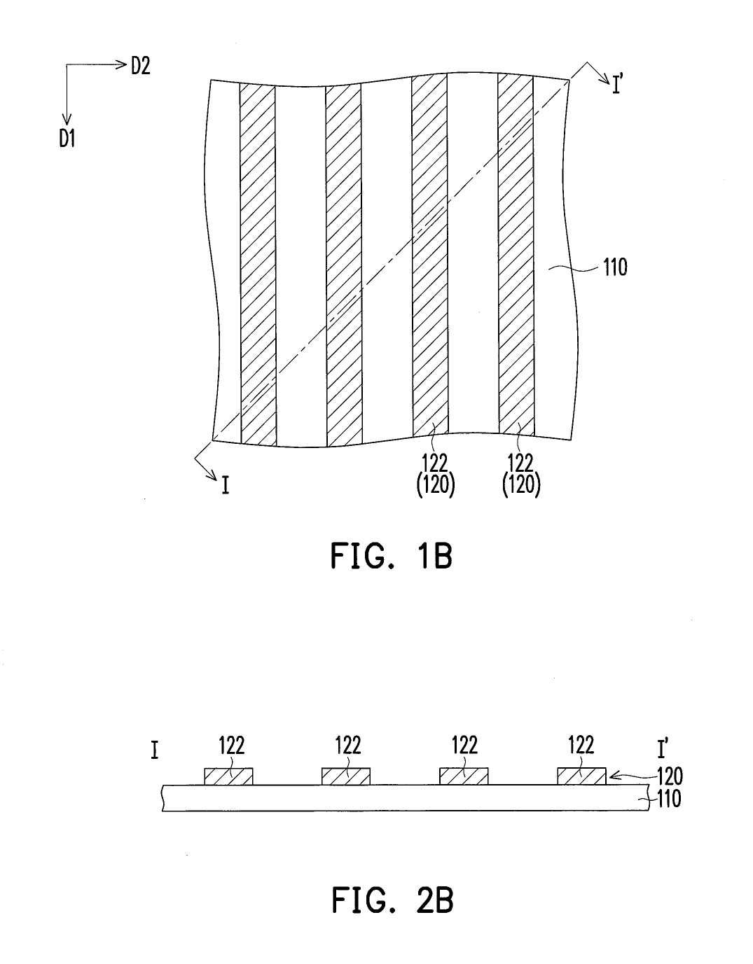

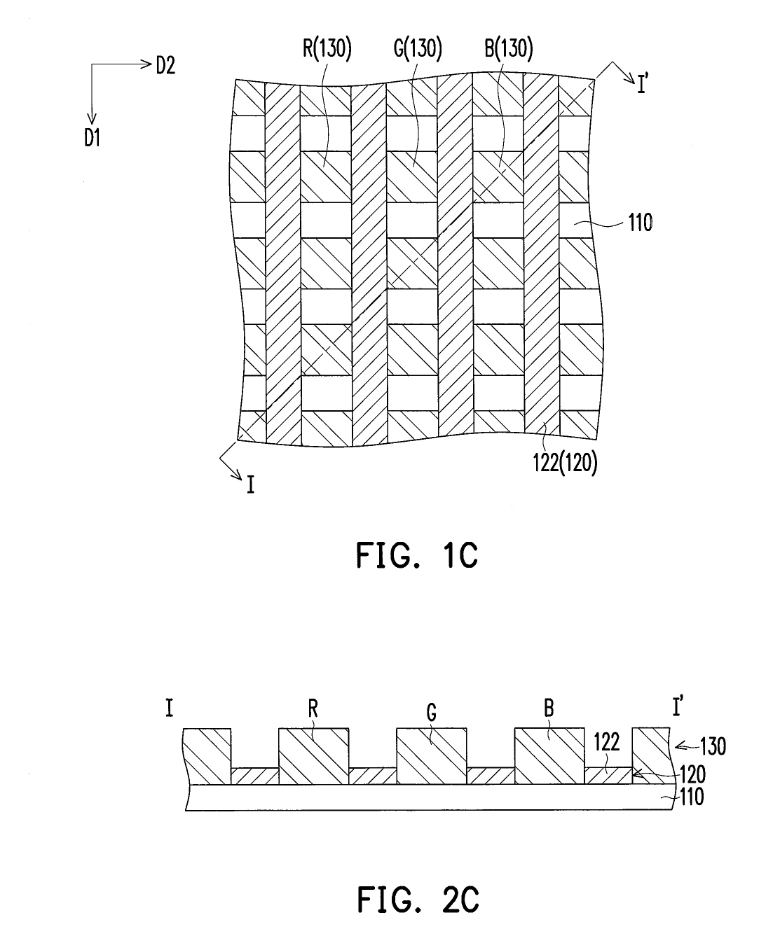

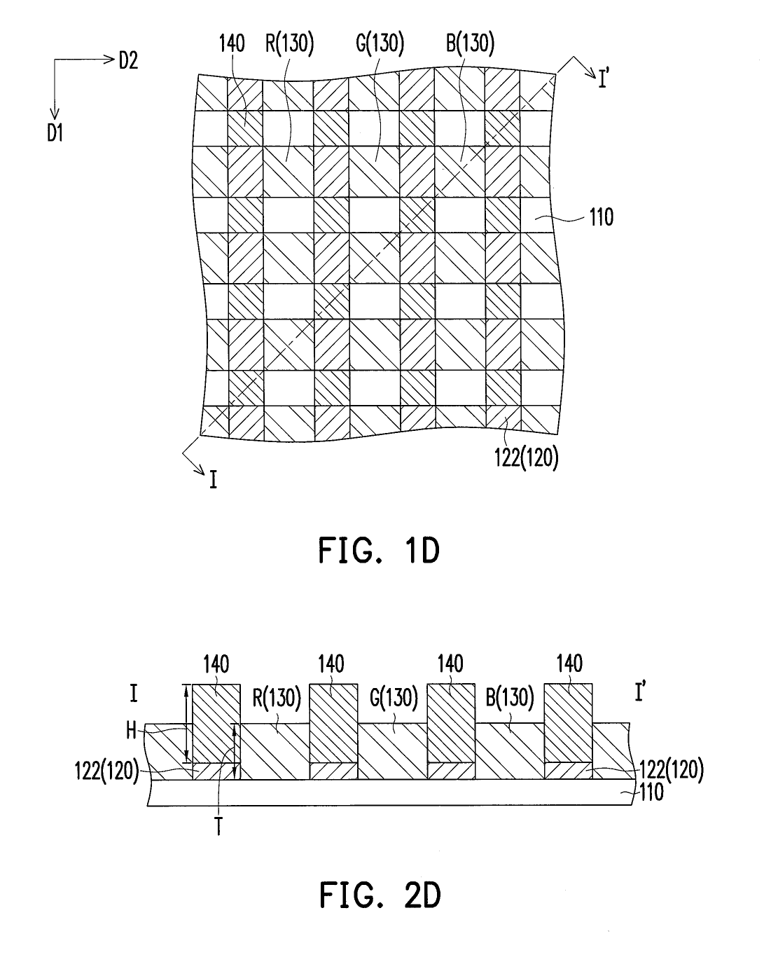

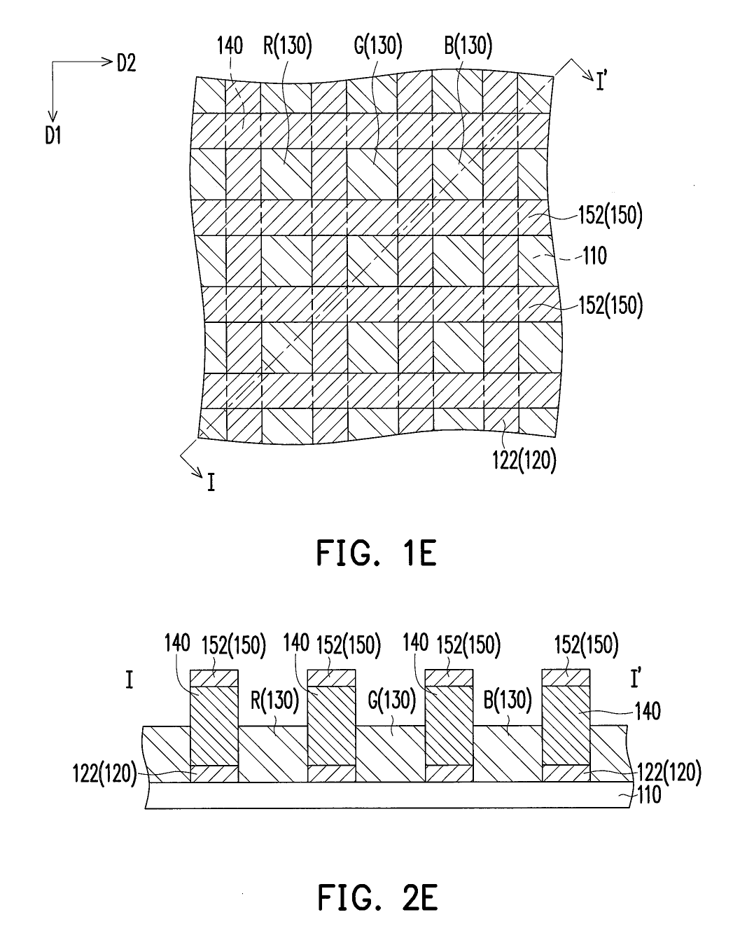

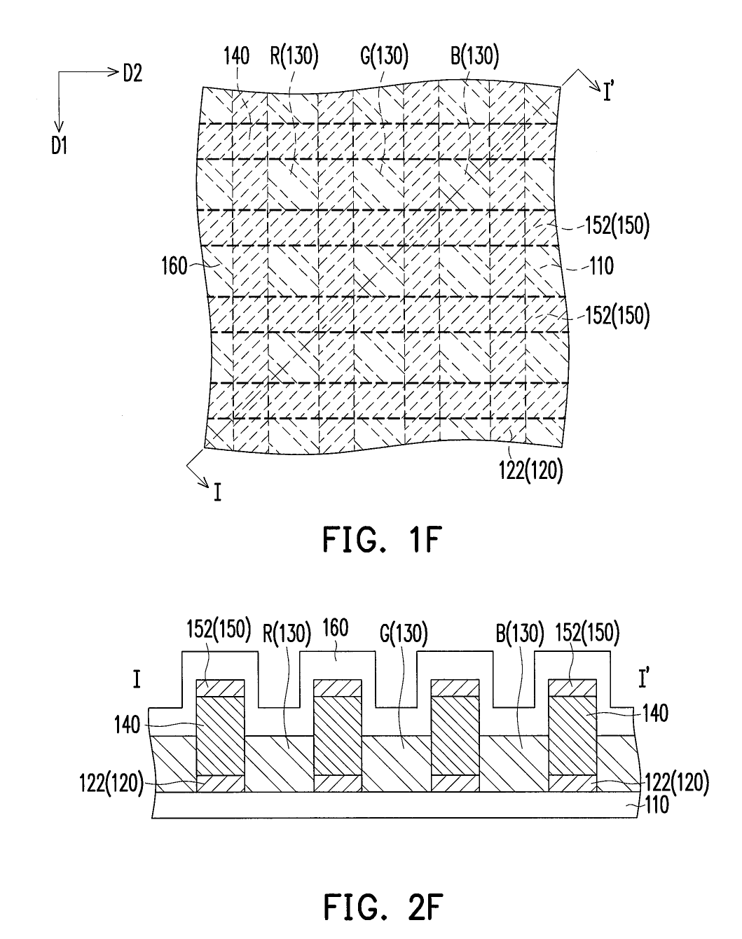

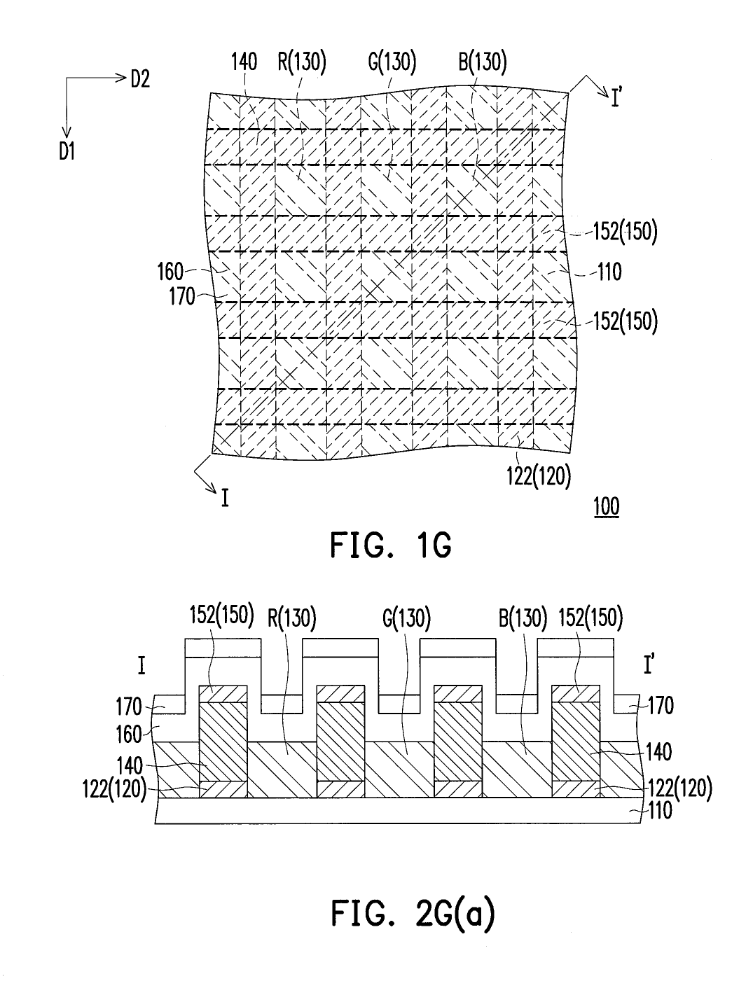

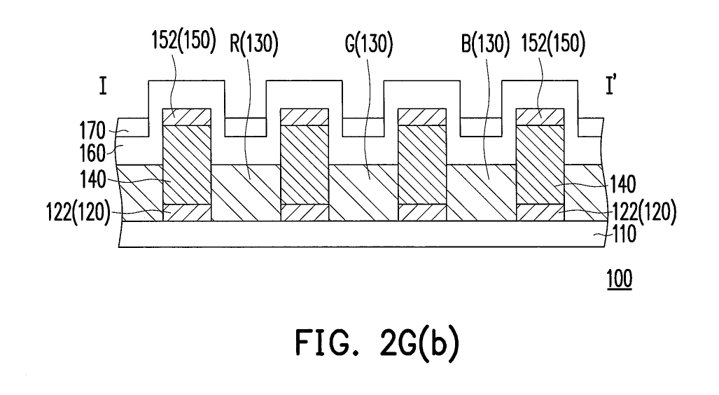

FIG. 1A to FIG. 1G are schematic top views illustrating a method for manufacturing a color film substrate according to a first exemplary embodiment, and FIG. 2A to FIG. 2G(b) are schematic cross-sectional views illustrating the manufacturing method of the color film substrate depicted in FIG. 1 along a line I-I′. The following below uses FIG. 1A to FIG. 1G and FIG. 2A to FIG. 2G(b) to sequentially describe the method for manufacturing the color film substrate 100 in detail according to the exemplar embodiment.

With reference to FIG. 1A and FIG. 2A, firstly, a substrate 110 is provided, wherein the substrate 110 is a glass substrate for instance, but the disclosure is not limited hereto.

With reference to FIG. 1B and FIG. 2B, a first conductive black matrix 120 is formed on the substrate 110, wherein the first conductive black matrix 120 extends along a first direction D1. In the embodiment, the first conductive black matrix 120 has a plurality of first strip conductive patterns 122, and the plurality of first strip conductive patterns 122 is electrically insulated from each others. Particularly, the first conductive black matrix 120 of the embodiment in addition to having good shading effect may also provide good conduction effect. Therefore, the martial of the first conductive black matrix 120 is metal, such as Chromium (Cr). Alternatively, the material of the first conductive black matrix 120 is semiconductor material, such as Carbon (C).

With reference to FIG. 1C and FIG. 2C, a color film layer 130 is formed on the substrate 110, and the normal projections of the color film layer 130 and of the first conductive black matrix 120 on the substrate 110 are not overlapping. In the embodiment, the color film layer 130 includes a plurality of red filter films R, a plurality of green filter films G and a plurality of blue filter films B, wherein the red filter film R, the green filter film G and the blue filter film B are arranged in matrix on the substrate 110 and are arranged alternatively with the plurality of first strip conductive patterns 122 of the first conductive black matrix 120. Although, the diagram shown in FIG. 1C illustrates the color filter films of same color are arranged in a row and the color filter films of the different colors are arranged in a column, the color filter films of different colors may be arranged in a row and the color filter films of same color may be arranged in a column in the other embodiments (not shown); or the color filter films of different colors may be arranged alternatively in row and column, but the disclosure is not limited hereto.

With reference to FIG. 1D and FIG. 2D, a plurality of insulating spacers 140 is formed on the first conductive black matrix 120. Specifically, the plurality of insulating spacers 140 is located on the first conductive black matrix 120, and the height H of the plurality of insulating spacers 140 is substantially greater than the thickness T of the color film layer 130. Furthermore, the material of the plurality of insulating spacers 140 has no electrical conductivity so as to enable the plurality of insulating spacers 140 to be directly disposed on the first conductive black matrix 120, which is electrical conductive, while not causing short circuit.

With reference to FIG. 1E and FIG. 2E, a second conductive black matrix 150 is formed on the substrate 110, wherein the second conductive black matrix 150 extends along a second direction D2 and covers the plurality of insulating spacers 140, and the second direction D2 intersects with the first direction D1. In the embodiment, the second conductive black matrix 150 has a plurality of second strip conductive patterns 152, wherein the plurality of second strip conductive patterns 152 is electrically insulated from each others, and the plurality of second strip conductive patterns 152 is substantially perpendicularly intersected with the plurality of first strip conductive patterns 122. Specifically, the second conductive black matrix 150 in addition to having good shading effect may also provide good conduction effect. Therefore, the material of the second conductive black matrix 150 is metal or semiconductor material, may be the same or different material as of the first conductive black matrix 120, and is for instance Chromium (Cr) or Carbon (C).

Since the height of the plurality of insulating spacers 140 is greater than the thickness of the color film layer 130, the insulating spacers 140 in addition to being the support for sustaining the spacing between the color film substrate 100 and the opposite substrate of subsequent application may also be the insulating layer between the first conductive black matrix 120 and the second conductive black matrix 150, thus capable of preventing the first conductive black matrix 120 and the second conductive black matrix 150 from direct contacting and causing short circuit.

With reference FIG. 1F and FIG. 2F, a passivation layer 160 is formed for covering the first conductive black matrix 120, the color film layer 130, the insulating spacers 140, and the second conductive black matrix 150.

Finally, with reference FIG. 1G and FIG. 2G(a), a transparent conductive layer 170 is formed on the passivation layer 160, wherein the transparent conductive layer 170 may be metal oxide such as Indium Tin Oxide (ITO), Indium Zinc Oxide (IZO), Aluminum Zinc Oxide (AZO), or other suitable transparent conductive materials. More specifically, the transparent conductive layer 170 is located on the passivation layer 160 above the color film layer 130 and on the passivation layer 160 above the second conductive black matrix 150, as shown in FIG. 2G(a). Certainly, in the other embodiments, the transparent conductive layer 170 may also be located on the passivation layer 160 above the color film layer 130, as shown in FIG. 2G(b), but the disclosure is not limited hereto.

Since the method for manufacturing the color film substrate 100 is to sequentially form the first conductive black matrix 120, the color film layer 130, the insulating spacers 140, the second conductive black matrix 150, the passivation layer 160 and the transparent conductive layer 170 on the substrate 110, wherein the height H of plurality of insulating spacers 140 is greater than the thickness T of the color film layer 130. Therefore, the insulating spacers 140 in addition to being the support for sustaining the spacing between the color film substrate 100 and the opposite substrate of subsequent application (not shown) may also be the insulating layer between the first conductive black matrix 120 and the second conductive black matrix 150. Consequently, in comparison with the conventional method for manufacturing the touch color film substrate, the manufacture of the color film substrate 100 of the embodiment may effectively reduce the manufacturing steps and the production cost.

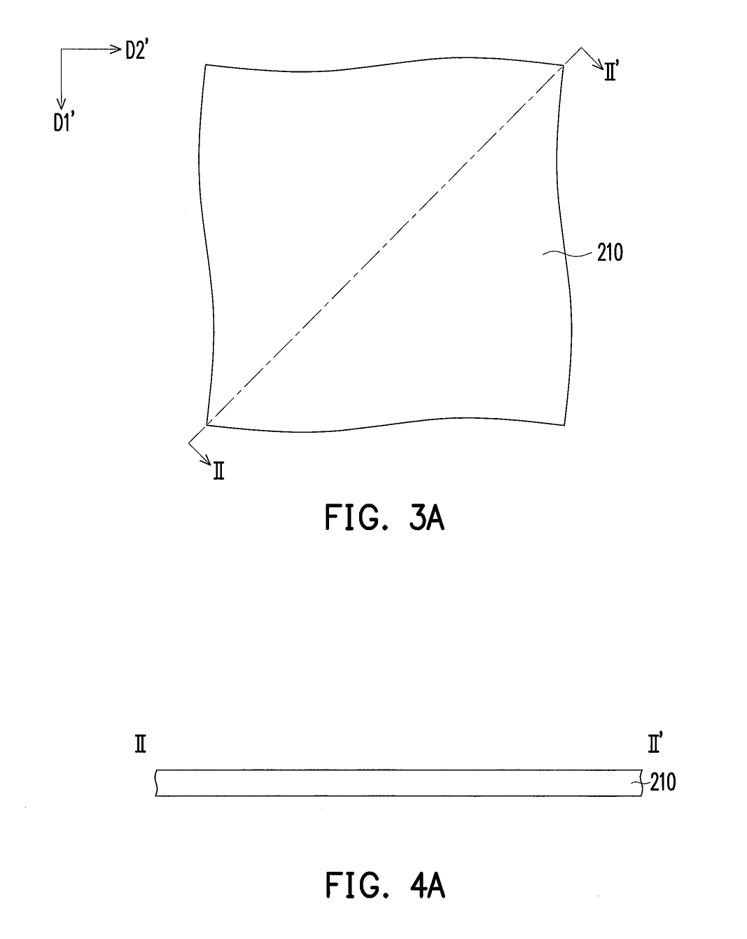

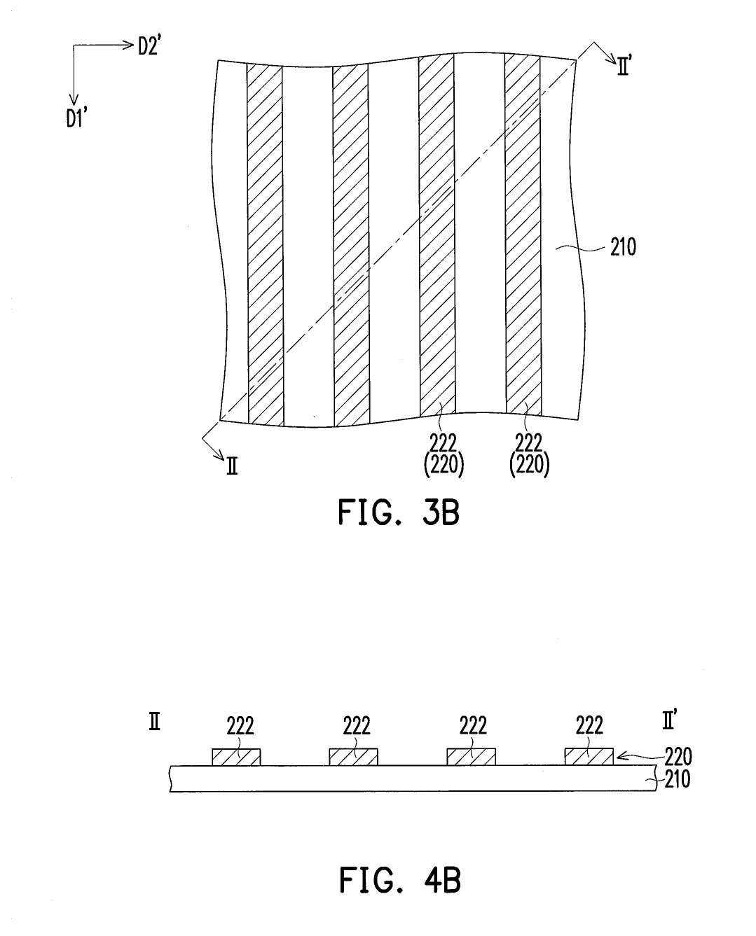

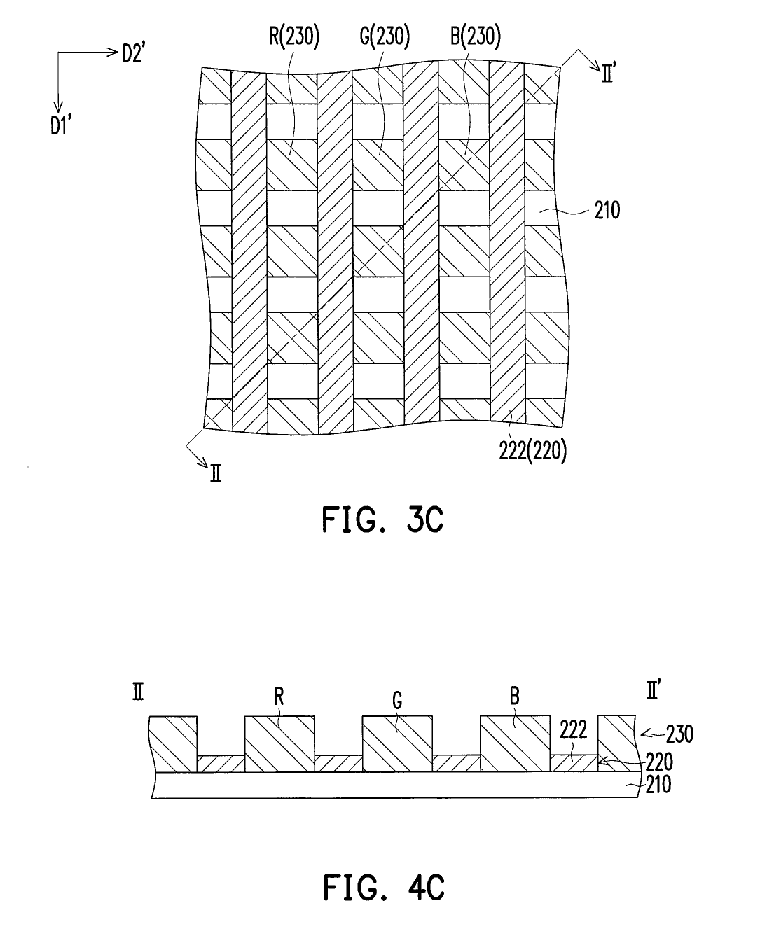

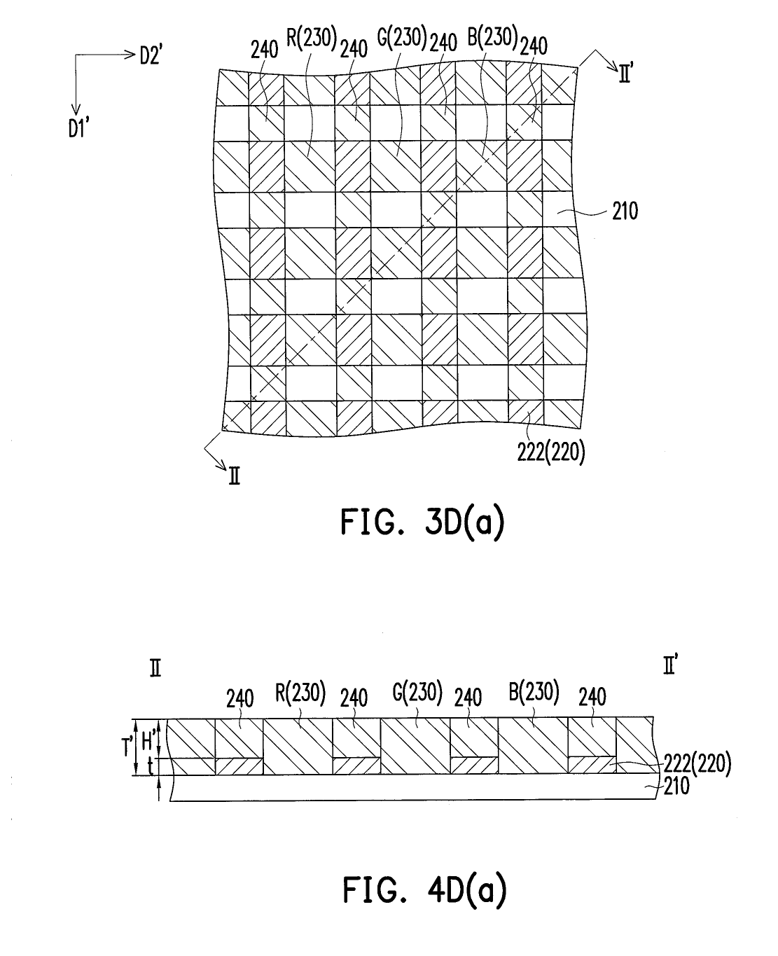

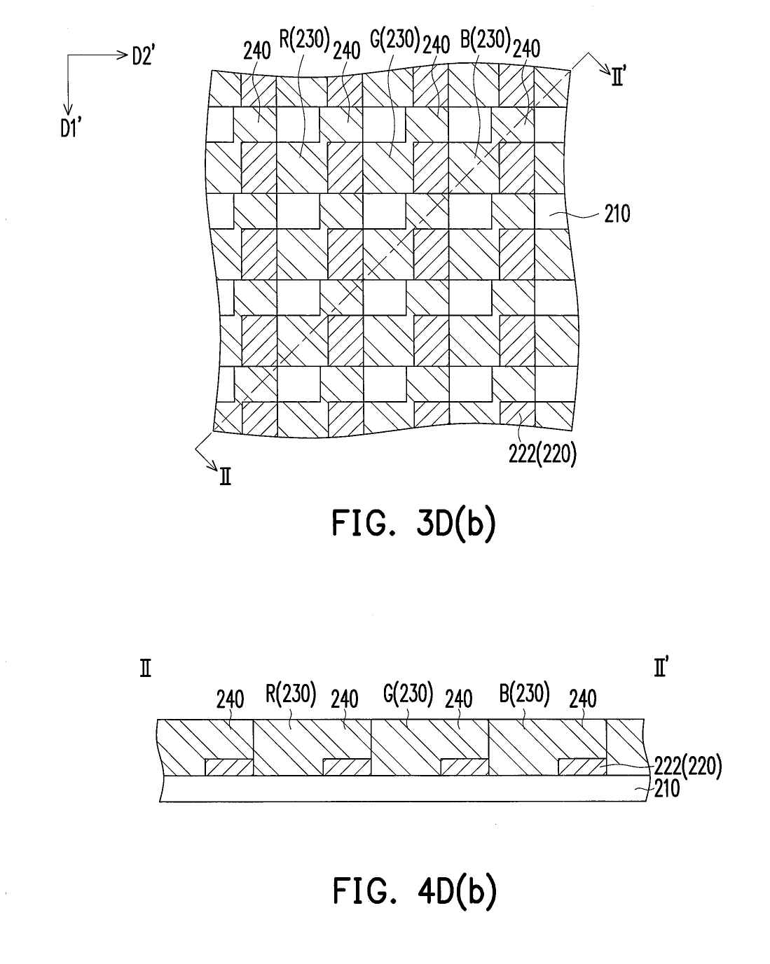

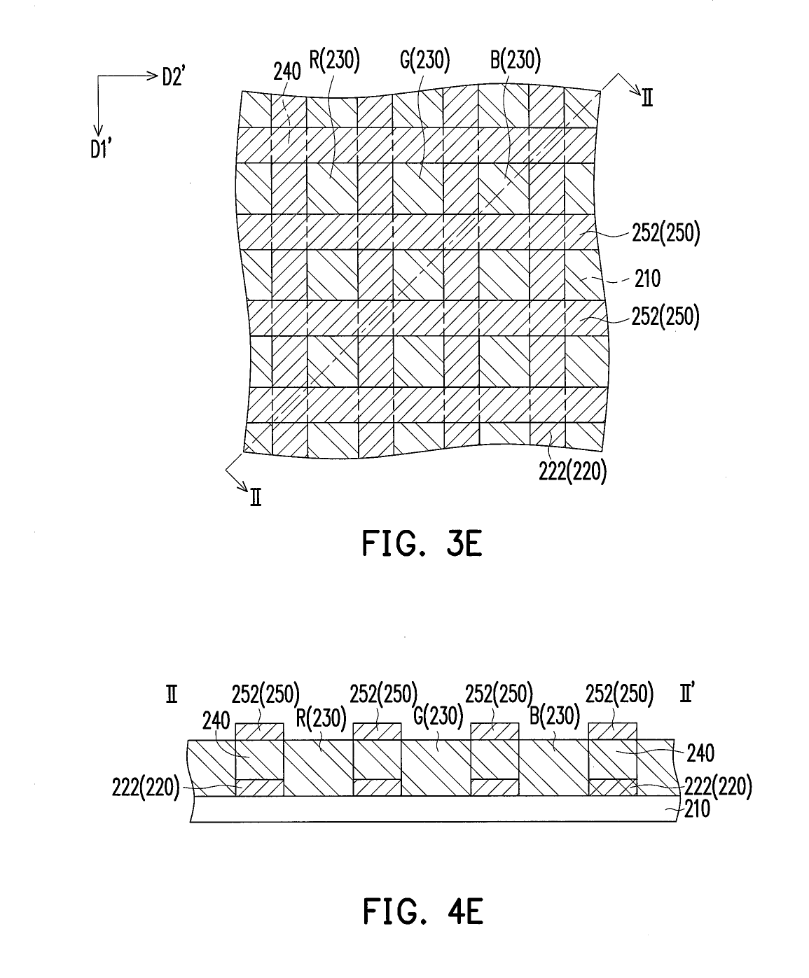

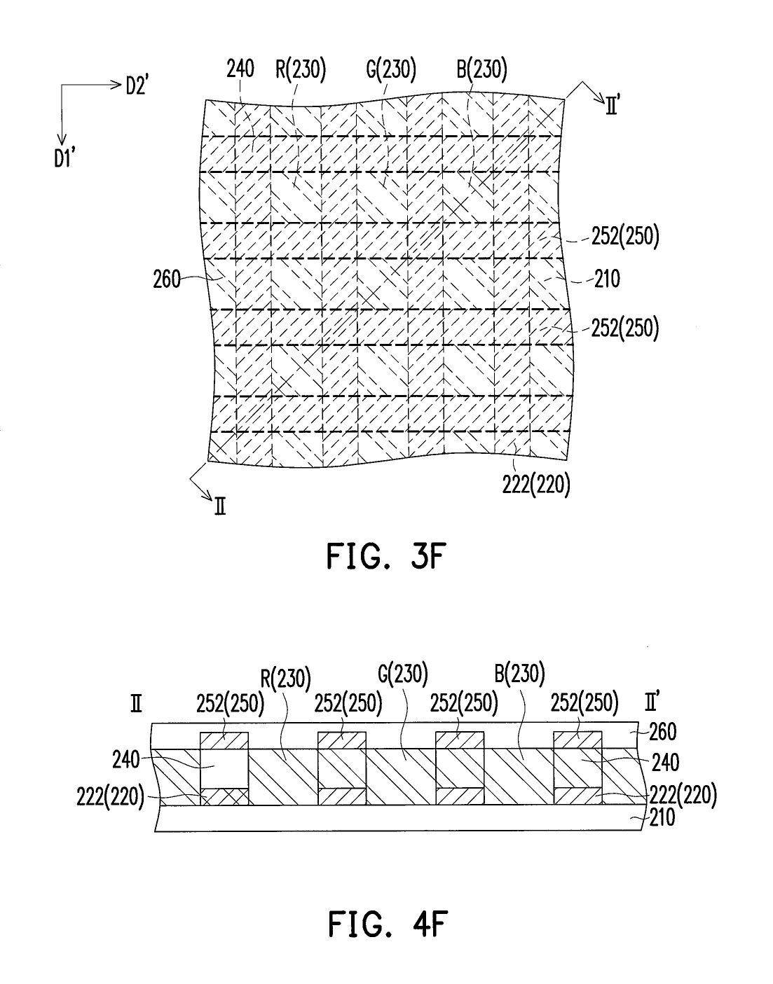

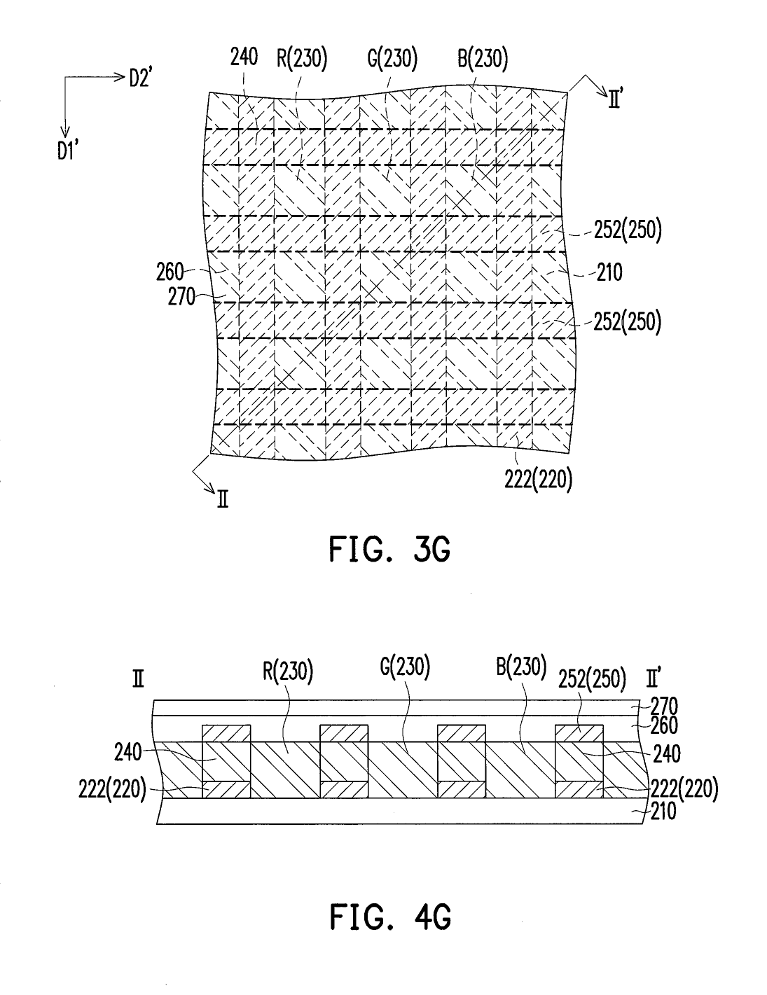

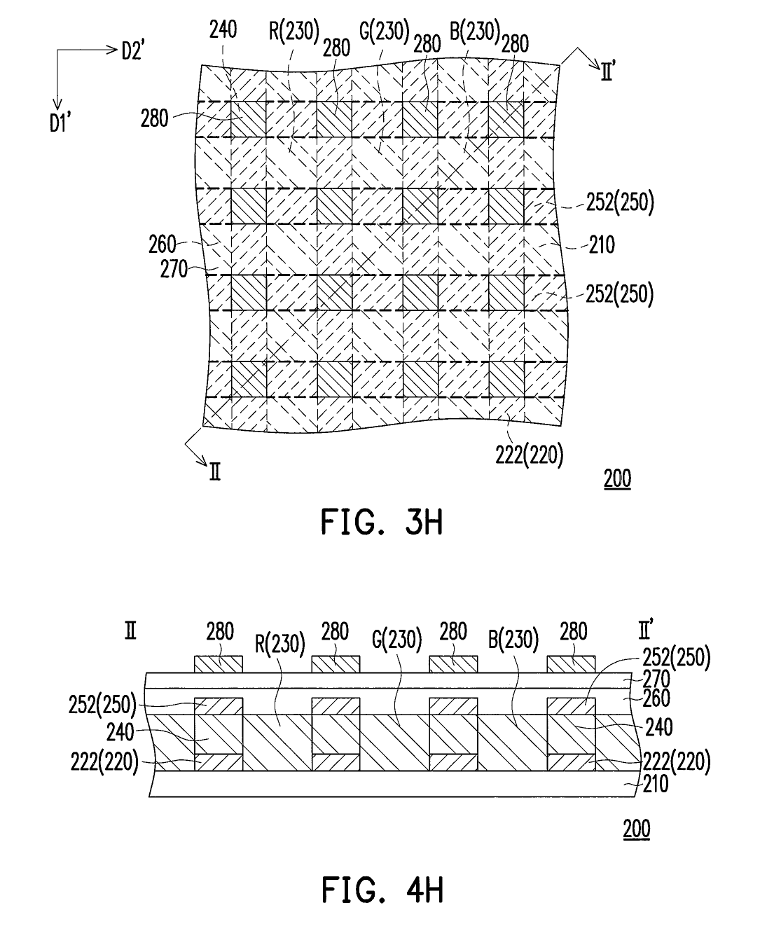

FIG. 3A to FIG. 3H are schematic top views illustrating a method for manufacturing a color film substrate according to a second exemplary embodiment, and FIG. 4A to FIG. 4H are schematic cross-sectional views illustrating the manufacturing method of the color film substrate depicted in FIG. 3 along a line The following below uses FIG. 3A to FIG. 3H and FIG. 4A to FIG. 4H to sequentially describe the method for manufacturing the color film substrate 200 in detail according to the exemplary embodiment.

With reference to FIG. 3A and FIG. 4A, firstly, a substrate 210 is provided, wherein the substrate 210 is a glass substrate for instance, but the disclosure is not limited hereto.

With reference to FIG. 3B and FIG. 4B, a first conductive black matrix 220 is formed on the substrate 210, wherein the first conductive black matrix 220 extends along a first direction D1′. In the embodiment, the first conductive black matrix 220 has a plurality of first strip conductive patterns 222, and the plurality of first strip conductive patterns 222 is electrically insulated from each others. Specifically, the first conductive black matrix 220 in addition to having good shading effect may also provide good conduction effect. Therefore, the material of the first conductive black matrix 220 is metal, such as Chromium (Cr). Alternatively, the material of the first conductive black matrix 220 is semiconductor material, such as Carbon (C).

With reference to FIG. 3C and FIG. 4C, a color film layer 230 is formed on the substrate 210, and the normal projections of the color film layer 230 and of the first conductive black matrix 220 on the substrate 210 are not overlapping. In the embodiment, the color film layer 230 includes a plurality of red filter films R, a plurality of green filter films G and a plurality of blue filter films B, wherein the red filter film R, the green filter film G and the blue filter film B are arranged in matrix on the substrate 210 and are arranged alternatively with the plurality of first strip conductive patterns 222 of the first conductive black matrix 220. Although, the diagram shown in FIG. 3C illustrates the color filter films of same color are arranged in a row and the color filter films of the different colors are arranged in a column, the color filter films of different colors may be arranged in a row and the color filter films of same color may be arranged in a column in the other embodiments (not shown); or the color filter films of different colors may be arranged alternatively in row and column, but the disclosure is not limited hereto.

With reference to FIG. 3D(a) and FIG. 4D(a), a plurality of first spacers 240 is formed on the first conductive black matrix 220. Specifically, the plurality of first spacers 240 is located on the first conductive black matrix 220, and the materials of the plurality of first spacers 240 and for the color film layer 230 are the same. Furthermore, the height H′ of the plurality of first spacers 240 and the thickness t of the first conductive black matrix 220 in total are equal to the thickness T′ of the color film layer so as to make the surface of the first spacer 240 and the surface of the color film layer 230 to become coplanar. Furthermore, the material of the first spacer 240 has no electrical conductivity so as to enable the plurality of insulating spacers 240 to be directly disposed on the first conductive black matrix 220, which is electrical conductive, while not causing short circuit.

Noteworthily, since the materials of the plurality of first spacers 240 and of the color film layer 230 are the same, the plurality of first spacers 240 and the color film layer 230 may be produced through the same manufacturing process. Moreover, the color film layer 230 of the present embodiment is not connected with the first spacer 240, as shown in FIG. 3D(a). In the other embodiment, the color film layer 230 may connect with the first spacer 240, as shown in FIG. 3D(b) and FIG. 4D(b), but the disclosure is not limited hereto.

With reference to FIG. 3E and FIG. 4E, a second conductive black matrix 250 is formed on the substrate 210, wherein the second conductive black matrix 250 extends along a second direction D2′ and covers the plurality of first spacers 240, and the second direction D2′ intersects with the first direction D1′. In the embodiment, the second conductive black matrix 250 has a plurality of second strip conductive patterns 252, wherein the plurality of second strip conductive patterns 252 is electrically insulated from each others, and the plurality of second strip conductive patterns 252 is substantially perpendicularly intersected with the plurality of first strip conductive patterns 222. Specifically, the second conductive black matrix 250 in addition to having good shading effect may also provide good conduction effect. Therefore, the material of the second conductive black matrix 250 is metal or semiconductor material, may be the same or different material as of the first conductive black matrix 220, is for instance Chromium (Cr) or Carbon (C). Furthermore, the plurality of first spacers 240 is located between the first conductive black matrix 220 and the second conductive black matrix 250, thus capable of preventing the first conductive black matrix 220 and the second conductive black matrix 250 from direct contacting and causing short circuit.

With reference to FIG. 3F and FIG. 4F, a passivation layer 260 is formed for covering the first conductive black matrix 220, the color film layer 230, the first spacer 240, and the second conductive black matrix 250.

With reference to FIG. 3G and FIG. 4G, a transparent conductive layer 270 is formed on the passivation layer 260, wherein the transparent conductive layer 270 may metal oxide, such as Indium Tin Oxide (ITO), Indium Zinc Oxide (IZO), Aluminum Zinc Oxide (AZO), or other suitable transparent conductive materials.

Finally, with reference to FIG. 3H and FIG. 4H, a plurality of second spacers 280 is formed on the transparent conductive layer 270, wherein the material of the plurality of second spacers 280 has no electrical conductivity so as to enable the plurality of second spacers 280 to be directly disposed on the transparent conductive layer 270, which is electrical conductive, while not causing short circuit. Furthermore, the normal projections of the plurality of second spacers 280 and of the plurality of first spacers 240 on the substrate 210 are overlapping. The plurality of second spacers 280 may be used as the support for sustaining the spacing between the color film substrate 200 and the opposite substrate of subsequent application (not shown).

Since the method for manufacturing the color film substrate 200 is to sequentially form the first conductive black matrix 220, the color film layer 230, the plurality of first spacers 240, the second conductive black matrix 250, the passivation layer 260, the transparent conductive layer 270 and the plurality of second spacers 280 on the substrate 210, wherein the materials of the plurality of first spacers 240 and of the color film layer 230 are the same. Therefore, the plurality of first spacers 240 in addition to being the insulating layer between the first conductive black matrix 220 and the second conductive black matrix 250 may also be produced along with the color film layer 230 through the same manufacturing process. Consequently, in comparison with the conventional method for manufacturing the touch color film substrate, the method for manufacturing the color film substrate 200 of the present embodiment may effectively reduce the manufacturing steps and the production cost.

Furthermore, the color film substrate 100 and the color film substrate 200, manufactured according to the method for manufacturing the color film substrate in the first exemplary embodiment and the second exemplary embodiment of the invention, may further be applied to the manufacture of the liquid crystal display panel.

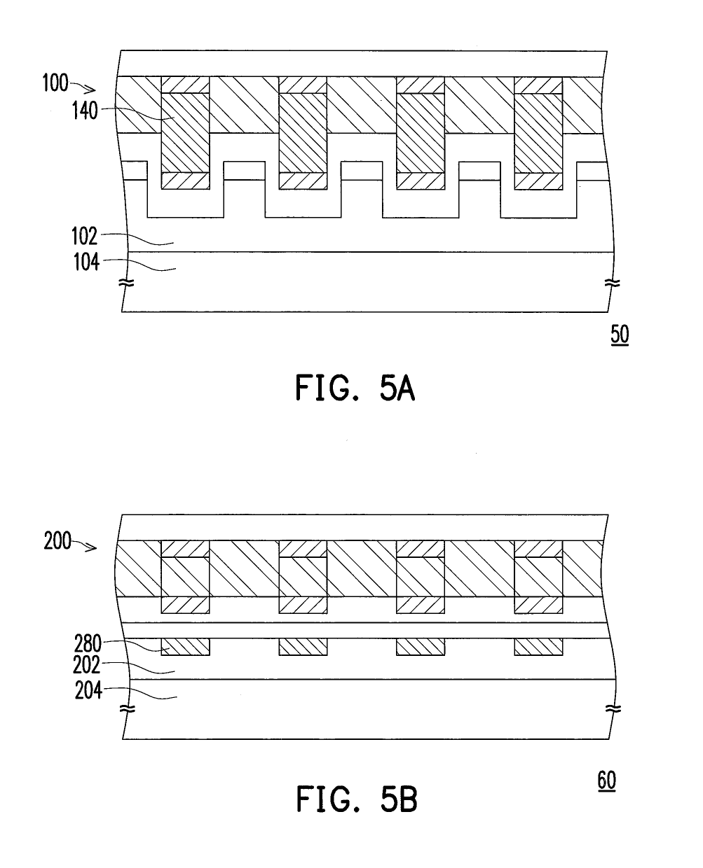

FIG. 5A is the schematic diagram illustrating the color film substrate depicted in FIG. 2G(b) being applied to the touch display panel. With reference to FIG. 5A, the color film substrate 100, manufactured according to the method for manufacturing the color film substrate in the first embodiment, may be applied to the manufacture of a liquid crystal display panel 50. The liquid crystal display panel 50 includes the color film substrate 100, a liquid crystal layer 102 and an opposite substrate 104. The color film substrate 100 is disposed opposite to the opposite substrate 104, the insulating spacers 140 of the color film substrate 100 is being used as the supporting for sustaining the spacing between the color film substrate 100 and the opposite substrate 104, and the liquid crystal layer 102 is disposed between the color film substrate 100 and the opposite substrate 104. Furthermore, the color film substrate 100 has touch function. Therefore, the liquid crystal display panel 50 may be a liquid crystal display touch panel.

FIG. 5B is schematic diagram illustrating the color film substrate depicted in FIG. 4H being applied to the touch display panel. With reference to FIG. 5B, the color film substrate 200, manufactured according to the method for manufacturing the color film substrate in the second embodiment, may be applied to the manufacture of a liquid crystal display panel 60. The liquid crystal display panel 60 includes the color film substrate 200, a liquid crystal layer 202 and an opposite substrate 204. The color film substrate 200 is disposed opposite to the opposite substrate 204, the plurality of second spacers 280 of the color film substrate 200 is being used as the support for sustaining the spacing between the color film substrate 200 and the substrate 204, and the liquid crystal layer 202 is disposed between the color film substrate 200 and the opposite substrate 204. Furthermore, the color film substrate 200 has touch function. Therefore, the liquid crystal display panel 60 may be a liquid crystal display touch panel.

In light of the foregoing, the invention provides the method for manufacturing the color film substrate by sequentially forming the first conductive black matrix, the color film layer, the plurality of insulating spacers, the second conductive black matrix, the passivation layer and the transparent conductive layer on the substrate, wherein the height of the plurality of insulating spacers is greater than the thickness of the color film layer. Therefore, the plurality of insulating spacers in addition to being the support for sustaining the spacing between the color film substrate and the opposite substrate may also be the insulating layer between the first conductive black matrix and the second conductive black matrix. Consequently, the method for manufacturing the color film substrate of the invention may effectively reduce the manufacturing steps and the production cost.

In addition, the invention further provides the method for manufacturing the color film substrate by sequentially forming the first conductive black matrix, the color film layer, the plurality of first spacers, the second conductive black matrix, the passivation layer, the transparent conductive layer and the plurality of second spacers on the substrate, wherein the materials of the plurality of first spacers and of the color film layer are the same. Therefore, the plurality of first spacers in addition to being the insulating layer between the first conductive black matrix and the second conductive black matrix may also be produced along with the color film layer through the same manufacturing process. Accordingly, the method for manufacturing the color film substrate of the invention may effectively reduce the manufacturing steps and the production cost.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A method for manufacturing a color film substrate comprising:
providing a substrate;
forming a first conductive black matrix extending along a first direction on the substrate;
forming a color film layer on the substrate, wherein the normal projections of the color film layer and of the first conductive black matrix on the substrate are not overlapping;
forming a plurality of insulating spacers on the first conductive black matrix, wherein the height of the plurality of insulating spacers is greater than the thickness of the color film layer;
forming a second conductive black matrix on the substrate, wherein the second conductive black matrix extends along a second direction and covers the plurality of insulating spacers, and the second direction intersects with the first direction;
forming a passivation layer to cove the first conductive black matrix, the color film layer, the plurality of insulating spacers, and the second conductive black matrix; and
forming a transparent conductive layer on the passivation layer.

2. The method for manufacturing the color filter substrate as recited in claim 1, wherein the first conductive black matrix has a plurality of first strip conductive patterns, and the plurality of first strip conductive patterns is electrically insulated from each others.

3. The method for manufacturing the color filter substrate as recited in claim 2, wherein the second conductive black matrix has a plurality of second strip conductive patterns, the plurality of second strip conductive patterns is electrically insulated from each others, and the plurality of second strip conductive patterns intersects with the plurality of first strip conductive patterns.

4. The method for manufacturing the color filter substrate as recited in claim 1, wherein the materials of the first conductive black matrix and of the second conductive black matrix are comprised of metal or semiconductor material.

5. The method for manufacturing the color filter substrate as recited in claim 1, wherein the color film layer comprises a plurality of red filter film, a plurality of green filter film and a plurality of blue filter film.

6. A method for manufacturing a color filter substrate comprising:
providing a substrate;
forming a first conductive black matrix extending along a first direction on the substrate;
forming a color film layer on the substrate, wherein the normal projections of the color film layer and of the first conductive black matrix on the substrate are not overlapping;
forming a plurality of first spacers on the first conductive black matrix, wherein the height of the plurality of first spacers and the thickness of the first conductive black matrix in total are equal to the thickness of the color film layer, and the materials of the plurality of first spacers and of the color film layer are the same;
forming a second conductive black matrix on the substrate, wherein the second conductive black matrix extends along a second direction and covers the plurality of first spacers, and the second direction intersects with the first direction;
forming a passivation layer to cover the first conductive black matrix, the color film layer, the plurality of first spacers, and the second conductive black matrix;
forming a transparent conductive layer on the passivation layer; and
forming a plurality of second spacers on the transparent conductive layer, wherein the normal projections of the plurality of second spacers and of the plurality of first spacers on the substrate are overlapping.

7. The method for manufacturing the color filter substrate as recited in claim 6, wherein the first conductive black matrix has a plurality of first strip conductive patterns, and the plurality of first strip conductive patterns is electrically insulated from each others.

8. The method for manufacturing the color filter substrate as recited in claim 7, wherein the second conductive black matrix has a plurality of second strip conductive patterns, the plurality of second strip conductive patterns is electrically insulated from each others, and the plurality of second strip conductive patterns is perpendicularly intersected with the plurality of first strip conductive patterns.

9. The method for manufacturing the color filter substrate as recited in claim 6, wherein the materials of the first conductive black matrix and of the second conductive black matrix are comprised of the metal or semiconductor material.

10. The method for manufacturing the color filter substrate as recited in claim 6, wherein the color film layer comprises a plurality of red filter films, a plurality of green filter films and a plurality of blue filter films.

11. The method for manufacturing the color filter substrate as recited in claim 6, wherein the color film layer connects with the plurality of first spacers.

12. The method for manufacturing the color filter substrate as recited in claim 6, wherein the color film layer is not connected with the plurality of first spacers.
